(19) United States
(12) Patent Application Publication
(10) Pub. No.: US 2022/0358379 A1
(43) Pub. Date: Nov. 10, 2022

(54) SYSTEM, APPARATUS AND METHOD OF MANAGING KNOWLEDGE GENERATED FROM TECHNICAL DATA

(71) Applicants: Samyak Jain, Bangalore, Karnataka (IN); Vinay Jayant Mundada, Pune, Maharashtra (IN); Chetan Jaydeep Ravada, Bangalore, Karnataka (IN); Kaushik S Kalmady, Bangalore, Karnataka (IN); Divja Nagaraju, Pune, Maharashtra (IN); Amlan Praharaj, Mumbai, Maharashtra (IN); Vinay Shankar Bhat, Ahmedabad, Gujarat (IN); Shailesh Vishvakarma, Dist-Navsari (IN); Srinidhi Kulkarni, Bangalore, Karnataka (IN)

(72) Inventors: Samyak Jain, Bangalore, Karnataka (IN); Vinay Jayant Mundada, Pune, Maharashtra (IN); Chetan Jaydeep Ravada, Bangalore, Karnataka (IN); Kaushik S Kalmady, Bangalore, Karnataka (IN); Divja Nagaraju, Pune, Maharashtra (IN); Amlan Praharaj, Mumbai, Maharashtra (IN); Vinay Shankar Bhat, Ahmedabad, Gujarat (IN); Shailesh Vishvakarma, Dist-Navsari (IN); Srinidhi Kulkarni, Bangalore, Karnataka (IN)

(21) Appl. No.: 17/624,249

(22) PCT Filed: Jul. 4, 2019
(86) PCT No.: PCT/EP2019/068025

§ 371 Date: Dec. 30, 2021

(51) Int. Cl. G06N 5/04; G06N 5/02; G06F 40/30

(52) U.S. Cl. CPC G06N 5/04; G06N 5/022; G06F 40/30

(57) ABSTRACT

System, apparatus and method for managing knowledge generated from technical data are disclosed. The method comprising receiving a user query for technical data stored as a knowledge base (842A) on a knowledge-based system (842); determining, by an inference engine (822), a contextual relevance between the user query and the knowledge base (842A), wherein the knowledge base (842A) comprises a query-able framework of the technical data including processed textual sections and indexed images; identifying textual sections and images of the knowledge base (842A) associated with the user query based on the contextual relevance; determining, by the inference engine (822), relevancy of the identified textual sections and indexed images based on frequency of terms in the query with respect to the identified textual sections and the indexed images; and generating, by the inference engine (822), a response (818A) to the user query including extracted textual sections and indexed images having a relevancy score that exceeds a threshold.

This application is the National Stage of International Application No. PCT/EP2019/068025, filed Jul. 4, 2019. The entire contents of this document are hereby incorporated herein by reference.

### BACKGROUND

Technical data in the form of technical literature such as scientific/technical documents like journal papers, design documents, etc. is often a source of information and knowledge for researchers, designers, and service engineers. During the design of complex machinery, often the designers have to be able to extract relevant information from a large body of technical data. Generally, the technical data is not available as plain text, but also contains images, figures, and formulae. Therefore, extracting relevant information may be time consuming and ineffective.

Further, extracting relevant information is especially tedious when the researchers, designers, and service engineers are unfamiliar with the technical data. Further, the designers/researchers may find it challenging to keep pace with rapid developments in their fields globally.

Some of the approaches to manage the technical data and extract relevant information include using keyword search and statistical word occurrence count methods. Other approaches include using tags for image retrieval, and using structured databases for storing data, which have been developed over the years by a community of experts. Further approaches may include using Optical Character Recognition (OCR), document image analysis, and hybrid approaches for formulae retrieval and extraction of triples. However, these approaches are unable to provide holistic information or rely on manual tagging. Further, the approaches are not suitable for technical data, especially in case of mathematical formulae. For example, handling such data streams may benefit from improvements.

### SUMMARY AND DESCRIPTION

The scope of the present invention is defined solely by the appended claims and is not affected to any degree by the statements within this summary.

According to a first aspect, a computer-based method for managing knowledge generated from technical data is disclosed. The method includes receiving a user query for technical data stored as a knowledge base on a knowledge-based system. The method further includes determining, by an inference engine, a contextual relevance between the user query and the knowledge base, where the knowledge base includes a queryable framework of the technical data including processed textual sections and indexed images. The inference engine further identifies textual sections and images of the knowledge base associated with the user query based on the contextual relevance, determines a relevancy score for each of the identified textual sections and indexed images based on frequency of terms in the query with respect to the identified textual sections and the indexed images, and generates a response to the user query including extracted textual sections and indexed images having a relevancy score that exceeds a threshold.

As used herein, “user query” includes any form of input from a user to the knowledge-based system such as textual query, image query, acoustic query, gesture-based, or a combination of the above. The user query maybe received and may also be analyzed by an inference engine. The “inference engine” may be a remote system configured to determine a contextual relevance between the user query and the knowledge base.

Also, “technical data” includes any form of technical literature including textual data, image data, audio data, video data, or any combination thereof. The technical data may be updated with newer technical literature at predetermined intervals to provide that the technical data is up to date. In an embodiment, where the technical data includes acoustic data or video data, the method may include converting the acoustic data into textual data using known neural networks. Similarly, the video data is converted to a combination of textual data and image data. As used herein, “indexed images” are used with reference to the images stored in the knowledge base. The indexed images are mapped to relevant textual sections and stored in the knowledge base. Therefore, the indexed images are stored intelligently with a relationship.

Further, “knowledge base” refers to a structured queryable framework of the technical data stored in a machine-readable format. The knowledge base is stored on one or more systems that are communicably coupled to each other. The one or more systems are referred to the knowledge-based system. In an embodiment, the method may include generating the knowledge base. The knowledge base maybe generated by a knowledge extraction engine.

To generate the knowledge base, the method may include formatting the technical data suitable for the queryable framework of the technical data. The formatting of the technical data provides that the knowledge base is generated independent of the file type, file version, etc., in which the technical data is made available.

Further, the method may include extracting the textual sections in the technical data based on semantic parsing of the technical data. Further, the method may include extracting the indexed images in the technical data by modifying the images in the technical data to identify regions of interest in the images.

In an embodiment, the semantic parsing of the technical data may be unsupervised. The semantic parsing may be performed using Markov Logic Network (MLN). The technical data may be clustered into logic clusters. The MLN combines the uncertainty and probability with the logic clusters in the technical data. Accordingly, through semantic parsing along with tautological knowledge, uncertain, ambiguous knowledge may also be captured in the knowledge base. Especially, with the use of MLN, uncertainty associated with the logic clusters may be explicitly encoded in the knowledge base. The MLN enables quick inference of the technical data to create an accurate, updatable, structured knowledge base.

The method of generation of the knowledge base is advantageous as the technical data that is unstructured in nature is converted into structured queryable framework of information. In an embodiment, the knowledge base is represented as a knowledge graph with technical data stored as the logical clusters. The knowledge base may be implemented using forest data-structures, whereby the logical clusters may be hierarchically arranged. Each of the logical clusters serve as decision trees that are merged together. In addition, the usage of unsupervised semantic parsing is advantageous as the knowledge base is able to inferentially store the logical clusters in the queryable framework.

To extract the textual sections in the technical data, the method may include identifying ambiguous terms in the textual sections and the indexed images. Further, the method may include co-referencing, by the inference engine, the ambiguous terms by mapping the ambiguous terms to non-ambiguous terms in the technical data. The “ambiguous terms” refers to terms in the technical data that do not have clear meaning and is capable of two or more often contradictory interpretations. Accordingly, “non-ambiguous terms” refers to terms in the technical data that have clear and definite meaning without any interpretations.

Examples of ambiguous terms in a technical document include pronouns such as “it”, “their”, “hereinabove”, “hereinafter”, etc. To lend meaning to the ambiguous terms, co-referencing is performed. The co-referencing may be performed using known natural language processing libraries. For example, co-referencing is performed by mapping the ambiguous terms to non-ambiguous terms in the associated footnote. Therefore, the method is advantageous as meaning for every term in the technical data is determined. The method may include extracting triples for the technical data with the non-ambiguous terms. The term “triples” refers to combination of the terms that may be structured as subject-verb-object. Accordingly, the triples reflect the technical data as subject-verb-object. The triples are extracted using techniques such as Open Information Extraction (OpenIE). To extract meaningful triplets, the ambiguous terms may be mapped to non-ambiguous terms in an embodiment. In another, the triples are refined using Schema Induction using Coupled Tensor Factorization (SICTF).

The method may further include determining Term Frequency (TF) and Inverse Document Frequency (IDF) for the triples. As used herein, “TF-IDF” refers to a weight used in information retrieval in scoring and ranking a relevance of a document given a query. This TF-IDF is a statistical measure used to evaluate how important a term is in the technical data. The importance increases proportionally to the number of times a word appears in the document but is offset by the frequency of the term in the technical data. Therefore, the TF-IDF enables narrowing of the user query to most relevant portions in the technical data.

The above-mentioned method to extract the textual sections may be contrasted with techniques using neural networks. Neural networks fail at answering inference questions. The neural network requires huge amount of training data samples to train the models, which needs to be cleaned, labelled, and balanced. Further, the neural network techniques are akin to black boxes, as the internal models used cannot be implicitly reasoned with, and hence, downstream modifications are difficult.

To extract the indexed images, the method includes modifying the images in the technical data to enhance contours of the images while reducing the dimensions of the images. Further, the method includes classifying the images into types of images as one of charts, graphs, 3-dimensional images, or 2-dimensional images using a convolutional neural network (CNN).

In an embodiment, the charts may be further classified to determine if the indexed image is a line chart/area chart, bar chart/column chart, or non-chart. The CNN is trained on samples of line/area charts, bar/column charts, and other figures present in pdfs as the non-chart class. In an embodiment, a Laplacian filter may be applied to the indexed image before feeding the indexed image to the CNN. The Laplacian filter helps in reducing the dimensionality of the image and exaggerates the contours in the image, enabling the model to distinguish better while training faster.

In addition, the method includes identifying the image-text on each of the images in the technical data. As used herein, the “image-text” includes text associated with the images in the technical data. Further, the method includes predicting the regions of interest in the images based on image-text identified on each of the images.

In an embodiment, an end-to-end neural network model is used as a text annotator for the indexed images. The end-to-end neural network takes, as input, an image and outputs all the text regions in the image. Because this is a single model performing text annotation in an end-to-end fashion, the end-to-end neural network model also reduces propagation of error as in case of pipelined models used for this task. Further, Object Code Recognition (OCR) algorithms may be used to extract the image-text in each of the text regions. The usage of the neural network improves the effectiveness of OCR algorithms. Accordingly, the present method is advantageous, as the image-text and the location of the image-text are determined effectively.

The method may therefore include identifying the image-text in each of the images in the technical data and determining the coordinates of the image-text in the image. Further, the method may include determining the relevancy of the image-text to the textual sections based on the coordinates of the image-text. Further, the method may include predicting the regions of interest in the images based on image-text identified on each of the images. In an embodiment, a mask Region Convolutional Neural Network (RCNN) may be used as the text annotator to identify the image-text and determining coordinates of the image-text. The RCNN predicts regions of interest where the RCNN believes that text exists, then generates exact masks within those regions of interests.

In an embodiment, the above-mentioned steps are performed prior to the receipt of the user query. Accordingly, the knowledge base is queried, and relevant response is provided to the user. Each of the method acts may be independently performed and can be further trained with additional technical data to improve the performance of the overall method.

When the user query is received, the method may include determining noun-phrases in the user query based on Parts of Speech (POS) tagging and noun chunking to determine the context relevancy. As used herein, “POS tagging” refers to grammatical tagging or word-category disambiguation. Example word-category includes nouns, pronouns, adjectives, verbs, adverbs, prepositions, conjunctions, and interjections. “POS tagging” includes known techniques of marking up a word in the user query as corresponding to a particular part of speech, based on both a word-category and a context. Further, as used herein, “noun chunking” refers to a process of extracting phrases from unstructured text by extracting named entities. For example, name entities may include name of a technical system such as gas turbine, rotor, induction motor, etc.

The method may include generating the relevancy score by comparing the triples in the knowledge base with the noun-phrases.

Further, the method may include determining a semantic similarity between the noun-phrases in the question with noun-phrases in the triples. Also, the method may include identifying the matching triples having noun-phrases that have similarity above a semantic threshold. The semantic threshold may be determined based on the user query or may be predetermined. For example, if the user query relates to critical operation parameters of a technical system, then the semantic threshold is higher. Accordingly, as used herein, “semantic threshold” refers to a benchmark of minimum semantic similarity between the noun phrases in the user query and the triplets in the knowledge base.

In addition, the method may include determining the associated indexed image for the user query. The indexed image may be determined using a n-gram model for the matching between the user query and the caption. As used herein, the n-gram model is a probabilistic linguistic model. In an embodiment, the images are mapped to associated text in the technical data and stored with the logic clusters in a logical relation structure in the knowledge base. The user query is analyzed with respect to the logical relation structure.

To determine an accurate response to the user query, the method may include determining query-term frequency and query-inverse document frequency for the user query. Further, the method may include comparing the query-term frequency and query-inverse document frequency with the term frequency and the inverse document frequency of the triples.

In some embodiments, the user query may be long or complicated. In such embodiments, the method may include generating one or more sub-queries for the user query. Further, the method may include generating a sub-response for each of the sub-queries.

Accordingly, the response to the user query is based on the sub responses. When generating the response to the user query, the method may include visualizing the matching triples as a knowledge graph and a knowledge panel. Further, the method may include rendering the knowledge graph and the knowledge panel as the response to the user query. In an embodiment, the knowledge panel may be rendered by a wearable device using known techniques in augmented reality.

The relevance and accuracy of the knowledge base may play a significant role in providing effective responses to the user query. Accordingly, the method may include managing the knowledge base on a distributed consensus-based ledger. Usage of the consensus-based ledge may provide a consensus with the owners or collaborators of the knowledge base. The consensus may be relevant for updating the knowledge base and/or the technical data that is used to generate the knowledge base.

According to a second aspect of the present embodiments, an apparatus for managing knowledge generated from technical data includes one or more processing units. The apparatus also includes a memory unit communicative coupled to the one or more processing units. The memory unit includes a knowledge management module stored in the form of machine-readable instructions executable by the one or more processing units.

Further, the knowledge management module is configured to perform one or more method aforementioned steps.

According to a third aspect, a system for managing knowledge generated from technical data includes a cloud computing platform. The system also includes a knowledge management module configured to perform one or more of the aforementioned method steps.

According to a fourth aspect of the present embodiments, a computer program product, having machine-readable instructions stored therein, that when executed by a processor, cause the processor to perform the aforementioned method act, is provided.

The present embodiments are not limited to a particular computer system platform, processing unit, operating system, or network. One or more aspects of the present embodiments may be distributed among one or more computer systems (e.g., servers configured to provide one or more services to one or more client computers, or to perform a complete task in a distributed system). For example, one or more aspects of the present embodiments may be performed on a client-server system that includes components distributed among one or more server systems that perform multiple functions according to various embodiments. These components include, for example, executable, intermediate, or interpreted code, which communicate over a network using a communication protocol. The present embodiments are not limited to be executable on any particular system or group of systems, and are not limited to any particular distributed architecture, network, or communication protocol.

### BRIEF DESCRIPTION OF THE DRAWINGS

The above-mentioned and other features of the invention will now be addressed with reference to the accompanying drawings of the present invention. The illustrated embodiments are intended to illustrate, but not limit the invention.

The present invention is further described hereinafter with reference to illustrated embodiments shown in the accompanying drawings, in which:

FIG. 1A is a flowchart of a method for managing knowledge generated from a knowledge base, according to an embodiment;

FIG. 1B is a flowchart of a method of generating a knowledge base for technical data, according to an embodiment;

FIG. 2 is a flowchart of a method of generating a knowledge base for technical data with mathematical formulae, according to an embodiment;

FIG. 3 is a flowchart of a method of generating a knowledge base for technical data with images, according to an embodiment;

FIG. 4 is a flowchart of a method of classifying the images in the technical data, according to an embodiment;

FIG. 5 is a flowchart of a method of predicting the regions of interest in the images in the technical data, according to an embodiment;

FIG. 6 is a flowchart of a method of determining the contextual relevance of the image-text in the images in the technical data, according to an embodiment;

FIG. 7 illustrates a block diagram of an apparatus for managing knowledge generated from technical data, according to an embodiment;

FIG. 8 illustrates a block diagram of a system for managing knowledge generated from technical data, according to an embodiment; and

FIG. 9 illustrates an embodiment of a graphical user interface providing a pictorial representation of a knowledge panel generated on a display unit of a wearable device.

### DETAILED DESCRIPTION

Hereinafter, embodiments for carrying out the present invention are described in detail. The various embodiments are described with reference to the drawings, where like reference numerals are used to refer to like elements throughout. In the following description, for purpose of explanation, numerous specific details are set forth in order to provide a thorough understanding of one or more embodiments. It may be evident that such embodiments may be practiced without these specific details.

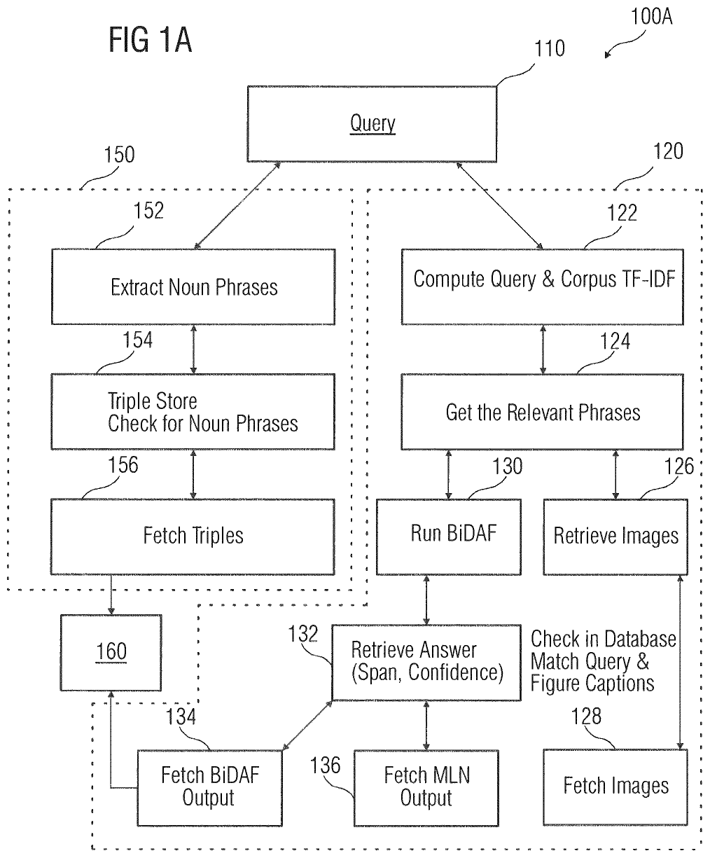

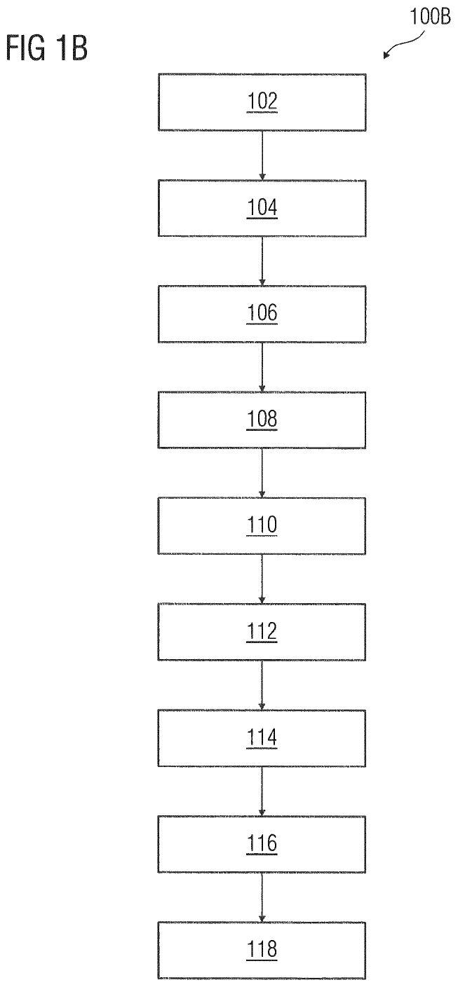

FIG. 1A is a flowchart of a method 100A for managing knowledge generated from knowledge base, according to an embodiment. The method 100 begins at act 110 with the receipt of a user query. The processing of the query may occur in separate pipelines. The processing pipelines are referred by the numbers 120 and 150 and may be implemented in parallel or sequentially. It will be appreciated by a person skilled in the art that the below explanation does not impact the sequence of implementation of the acts. At act 122, term frequency and inverse document frequency of the user query and of the technical data in the knowledge base is determined. For clarity, the term frequency for the user query is referred to as query-term frequency, and the inverse document frequency is referred to as query-inverse document frequency.

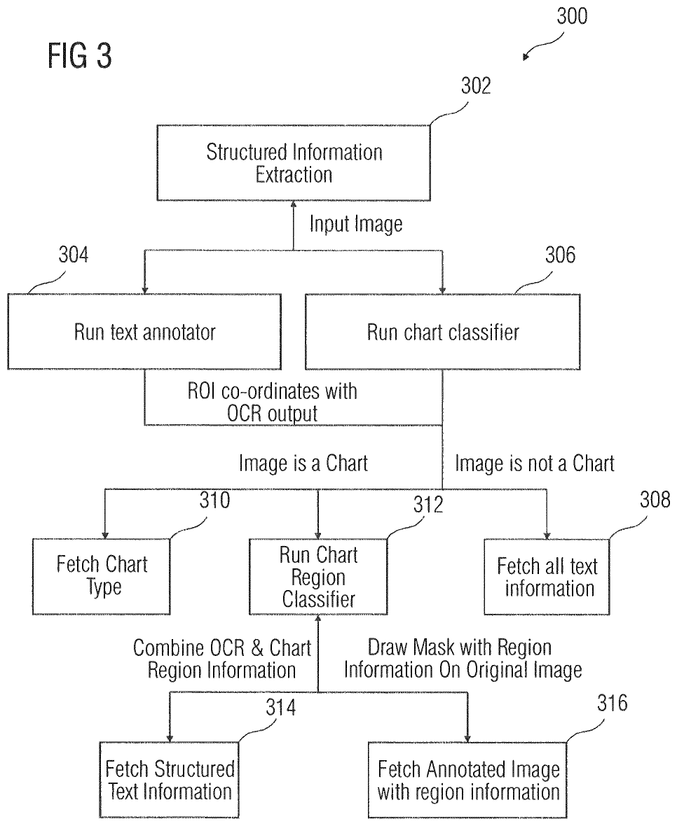

At act 124, the query-term frequency and query-inverse document frequency is compared with the term frequency (TF) and the inverse document frequency (IDF) associated with the technical data in a knowledge base. The comparison enables determination of a contextual relevance between the user query and the knowledge base including textual sections and indexed images. Acts 126 and 128 relate to narrowing down on the indexed image associated with the user query. At act 126, the indexed images are retrieved from the knowledge base. In an embodiment, the indexed images are extracted based on comparison of the query-term frequency and query-inverse document frequency with the TF-IDF of captions associated with the indexed images. The act 126 of retrieving the indexed images also includes the act 128 of extracting the indexed images from the technical data. The process of extracting the indexed images from the technical data to generate the knowledge base is explained in FIG. 3.

Acts 130-136 relate to narrowing down on the textual sections associated with the user query. At act 130, the textual sections are shortlisted based on the contextual relevance. The shortlisted textual sections are analyzed using a deep-learning neural network. Example deep-learning network includes a Bi-Directional Attention Flow (BiDAF) network that is configured to identify character-level, word-level, and contextual embeddings, and uses bi-directional attention flow to obtain a query-aware textual section.

At act 132, the shortlisted textual sections are highlighted with a relevancy score. The relevancy score refers to the relevancy of the shortlisted textual section to the user query. At act 134, the output of the deep-learning network is retrieved. To provide the shortlisted textual sections, the act 136 may need to be performed in parallel or a pre-step. When the user query is not factoid type and may require inferencing, act 136 is performed. At act 136, the user query is analyzed through semantic parsing. The semantic parsing may be performed using Markov Logic Network (MLN). The MLN determines an uncertainty and a probability that the shortlisted textual section is relevant to the user query. Accordingly, the semantic parsing is used to generate the relevancy score. Apart from the pipeline 120, the user query is analyzed under pipeline 150. At act 152, noun phrases are extracted from the user query. In an embodiment, the noun phrases may be extracted using Part of Speech processing techniques. In another embodiment, the noun phrases are extracted based on noun chunking techniques.

At act 154, the noun phrases are compared with triples generated from the technical data. Act 154 also includes generating the relevancy score by comparing the triples in the knowledge base with the noun-phrases. The method of generating the triples is further explained in FIG. 1B. At act 156, the triples with the relevancy score greater than a semantic threshold are extracted. The triples include the extracted textual sections and associated indexed images.

Both the pipelines 120 and 150 culminate at act 160. At act 160, a response to the user query is generated. The response includes extracted textual sections and indexed images. The response to the user query may be rendered on a Graphical User Interface on a user device. The response may also be rendered via a wearable device such that the response is super-imposed on a system associated with the user query.

In the above method, the technical data is provided in the knowledge base. The knowledge base is a queryable framework of the technical data. The knowledge base enables the technical data to be accessible in terms of logical relationships. Accordingly, the knowledge base facilitates accurate and fast responses to the user query. Therefore, the method of generating the knowledge base may precede the method 100A.

FIG. 1B is a flowchart of one embodiment of a method 100B of generating a knowledge base for technical data, according to an embodiment. The method begins at act 102, in which the technical data is formatted. Formatting enables the technical data to be stored as a queryable framework. Further, the formatting of the technical data provides that the knowledge base is generated independent of the file type, version, etc., in which the technical data is made available. For example, the technical data in audio data format is converted into text data format. The conversion enables the audio data to be queried.

At act 104, the textual sections in the technical data are extracted based on semantic parsing of the technical data. The semantic parsing of the technical data may be performed using Markov Logic Network (MLN). The technical data is formed into logic clusters. The MLN enables tautological knowledge, uncertain, ambiguous knowledge to be captured in the knowledge base.

Further, to enable extraction of relevant textual sections in the technical data, the method may include identifying ambiguous terms in the textual sections. Accordingly, at act 106, the method may include co-referencing ambiguous terms by mapping the ambiguous terms to non-ambiguous terms in the technical data. The “ambiguous terms” refer to terms in the technical data that do not have clear meaning and are capable of two or more often contradictory interpretations. Accordingly, “non-ambiguous terms” refer to terms in the technical data that have clear and definite meaning without any interpretations. Examples of ambiguous terms in technical document include pronouns such as “it”, “their”, “hereinabove”, “hereinafter”, etc. To lend meaning to the ambiguous terms, co-referencing is performed.

At act 108, triples for the technical data with the non-ambiguous terms is extracted. The term “triples” refers to a combination of the terms that may be structured as subject-verb-object. Accordingly, the triples reflect the technical data as subject-verb-object. The triples are extracted using techniques such as Schema Induction using Coupled Tensor Factorization (SICTF) and Open In formation Extraction (OpenIE). To extract meaningful triplets, act 106 may be performed prior to act 108.

The knowledge base also includes indexed images in the queryable framework. The acts 110-118 are directed to processing of images to extract the indexed images from the technical data. The processing of images is performed using a Convolutional Neural Network (CNN). At act 110, the images in the technical data are modified to enhance contours of the images while reducing the dimensions of the images. In an embodiment, a Laplacian filter may be applied to the image. The Laplacian filter helps in reducing the dimensionality of the image as well as exaggerates the contours in the image enabling the model to distinguish better while training faster.

At act 112, the images are classified into types of images as charts, graphs, 3-dimensional images, or 2-dimensional images using the CNN. For example, the CNN is trained on samples of line/area charts, bar/column charts as a chart class, and other figures present in pdfs as a non-chart class.

At act 114, image-text is identified on each of the images in the technical data. As used herein, the “image-text” includes text associated with the images in the technical data.

In an embodiment, the CNN is used as a text annotator for the images that takes an image as input image and outputs all the text regions in an image.

At act 116, the image-text is identified along with determination of coordinates of the image-text in the image. Further, act 116 may include determining the relevancy of the image-text to the textual section based on the coordinates of the image-text. At act 118, regions of interest in the images are predicted based on image-text and the coordinates of the image-text on each of the images. In an embodiment, a mask Region Convolutional Neural Network (RCNN) may be used as the text annotator to identify the image-text and determining coordinates of the image-text. The RCNN predicts regions of interest where the RCNN believes that text exists, then generates exact masks within those regions of interests.

Through the method 100B, the technical data that is unstructured in nature is converted into structured query-able framework of logically related information. In an embodiment, the knowledge base is represented as a knowledge graph with technical data stored as logical clusters. The knowledge base may be implemented using forest data-structures, whereby the logical clusters may be hierarchically arranged. Further, the usage of unsupervised semantic parsing is advantageous, as the knowledge base inferentially stores the textual sections and the indexed images as logical clusters in the query-able framework. Further, by indexing the images in the technical data, relevant images may be provided as the response to the user query.

Technical data generally includes mathematical equations and formulae. Generally, the mathematical formulae are represented in the form of specialized characters. Sometimes, different sources of technical data represent the same mathematical formulae with different specialized characters. The present embodiments address the above challenge by generating the knowledge base including the mathematical formulae, such that the formulae are rendered queryable.

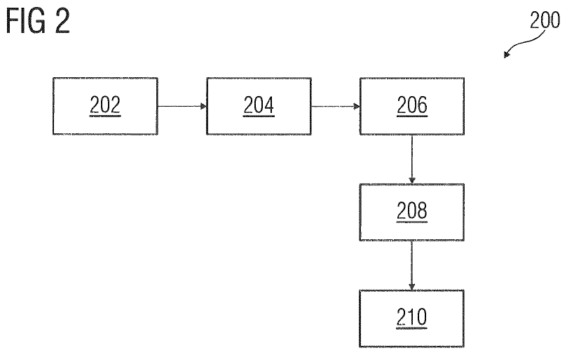

FIG. 2 is a flowchart of a method 200 of generating a knowledge base for technical data with mathematical formulae, according to an embodiment. The method begins at act 202 with extraction of all characters from the technical data from different sources. At act 204, characters that have the most common font are selected. The characters are generally selected from the technical data present as paragraphs. The common characters are grouped separately into multiple sections collectively referred as “common-chars”. At act 206, the “common-chars” is analyzed to determine whether a space character is the only character in a given section, in which case, such a section may be removed.

At act 208, the technical data is analyzed to identify sections with formula characters. Formula characters are a predefined set of characters often present in formulae. Accordingly, sections that predominantly include the formula characters are identified. Further, at act 208, the technical data is classified as formula regions and non-formula regions based on co-ordinates of the formula characters. At act 210, the formula characters are extracted from the formula regions and mapped to the “common-chars” to derive meaning for each of the formula characters. Formula characters with similar meaning are logically stored in the knowledge base.

In certain embodiments, additional processing acts may be performed to effectively identify and extract formula characters. For example, the steps may include removing images and captions found around the formula characters and classifying these as the non-formula regions. The captions may then be further used to derive meaning of the associated formula characters.

FIG. 3 is a flowchart of a method 300 of generating a knowledge base for technical data with images, according to an embodiment. At act 302, an image is input to a knowledge extraction engine. The knowledge extraction engine may perform acts 304 and 306 parallelly or sequentially.

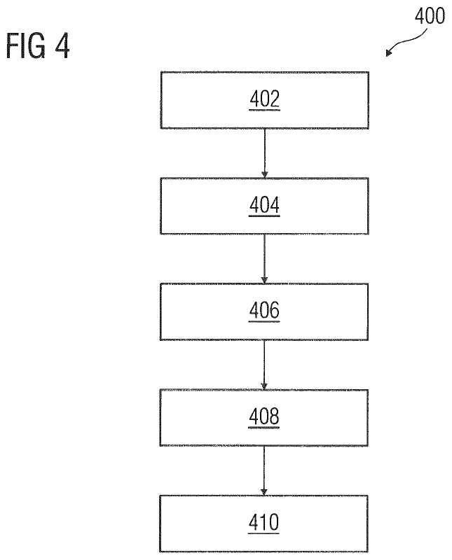

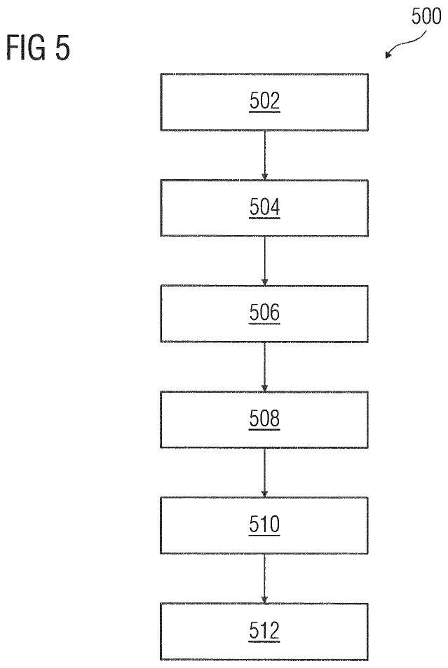

At act 304, the image is analyzed by text annotator and OCR algorithms. FIGS. 5-7 elaborate the sub-acts performed at act 304. At act 306, the image is classified as chart or not a chart. The act 306 is explained in detail in FIG. 4. At the end of acts 304 and 306, the knowledge extraction engine is configured to determine co-ordinates of regions of interest and identify the image-text. At act 308, the image-text associated with the image is analyzed through semantic parsing to determine the contextual relevance of the image-text and the image.

In case the image is a chart, acts 310-316 may be performed in addition to act 308. At act 310, a chart type is determined is determined for the image. The chart type is determined using a multi layered 2-D CNN. Example chart types include pie chart, bar graph, etc. At act 312, a chart region is determined to separate the image-text from the region of interest. Accordingly, act 312 includes a combination of OCR detection and masking of regions of non-interest.

At act 314, the image-text is analyzed in relation to the chart type to determine the contextual relevance of the image-text and the chart. At act 316, the image is annotated with the contextual relevance and stored in the knowledge base.

FIG. 4 is a flowchart of one embodiment of a method 400 of classifying the charts in the technical data, according to an embodiment. At act 402, the images are resized to a fixed dimension to provide uniform input dimension. For example, the images are resized to dimension of 256×256×3 pixels. At act 404, the resized images are passed through a filter that exaggerates the contours of the image while reducing the dimensionality. For example, using Laplacian filter, the dimensionality of the resized image is reduced to 256×256×1 pixels as compared to 256×256×3 pixels.

At act 406, the reduced images are further processed to produce a shrunken output in the image input plane and an increased dimension in a channel axis. The reduced images may be processed using a stride of 2 and 32 filters. At act 408, the reduced images are also processed using CNN. For example, 3 additional CNN layers, each separated by a Batch Normalization and Dropout layer, are used to process the reduced images.

At act 410, the output from act 408 is passed through a max pooling layer, and then flattened to produce a 1-dimensional output. Further, the 1-dimensional output is then fed into a fully connected layer to produce a softmax output for the chart types. Accordingly, at act 410, probability of the chart type is determined. The largest probability corresponding to a predicted chart type is considered as the chart type.

It will be appreciated by a person skilled in the art that the above-mentioned acts 402-410 may be implemented as a single neural network having multiple layers.

FIG. 5 is a flowchart of a method 500 of predicting the regions of interest in the images in the technical data, according to an embodiment. The method 500 may be implemented on a mask Region-CNN (RCNN). The mask RCNN may be initially trained on a sample of 100 images in which the image-text regions were manually annotated.

At act 502, the images are pre-processed to make sure the images are rescaled to a standard size. This act may introduce padding on the resized image in order to preserve an aspect ratio.

At act 504, the processed images are passed through the mask RCNN to predict the regions of interest associated with probable image-text regions in the image. At act 506, a confidence score for each image-text region is determined. In an embodiment, a threshold of 0.5 is used on the confidence score to identify whether a region as text or background. At act 508, based on the confidence score, the regions of interests are determined. The determination is done on the processed images with padding. Accordingly, at act 510, padded regions are trimmed from the processed image. Further, the ROI coordinates are updated with respect to these new coordinates after the trimming.

In case the mask RCNN predicts large regions of interests, the act 512 is performed. To obtain fine-tuned regions of interests, regions that have size greater than a size threshold are filtered. For example, the size threshold is 0.3 times the area of the image. Another example of the size threshold is when height/width is greater than half the height or width of the image, respectively.

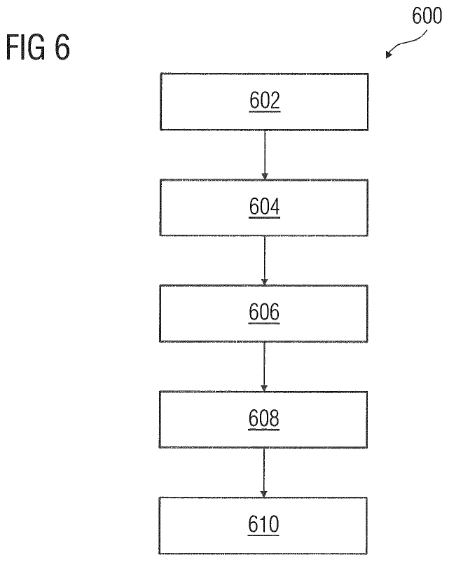

FIG. 6 is a flowchart of a method 600 of determining the contextual relevance the image-text in the images in the technical data, according to an embodiment. The method 600 is performed in furtherance to the method 500. At act 602, the regions of interest generated in FIG. 5 are converted to gray scale. Further, at act 604, OTSU thresholding applied to binarize the regions of interest. At act 606, median blurring is applied to remove any noise in the regions of interest.

At act 608, the regions of interests are processed by an OCR algorithm. Example OCR algorithm is a tesseract OCR engine that is configured to predict the contextual relevance of the image-text. The prediction is based on the semantic similarity between the textual sections in the technical data and the image-texts. At act 610, each image is annotated with bounding boxes in the image that contain image-texts and the OCR predictions for the image-texts.

In an embodiment, the method 600 will be implemented as follows. The coordinates of the regions of interest are determined. Further, the regions of interests are classified into title, x-title, y-title, x-label, y-label, and miscellaneous text. The classification is performed based on the coordinates of the regions of interest (e.g., if the region of interest is in the top left corner or the bottom right corner of the image). These features enable the machine learning algorithm to clearly distinguish the different kinds of image-text and the associated contextual relevance.

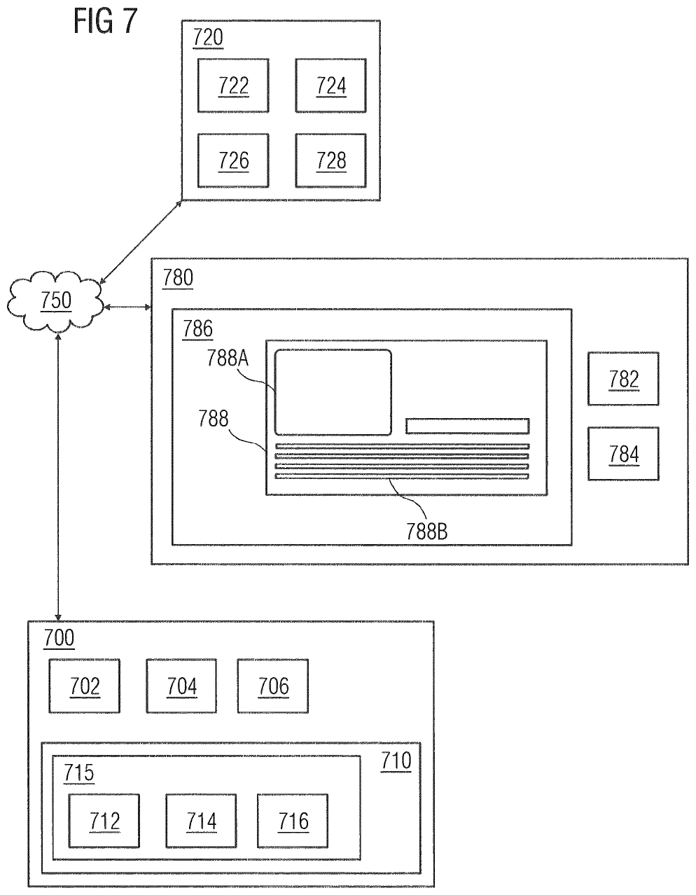

FIG. 7 illustrates a block diagram of an apparatus 700 for managing knowledge generated from technical data, according to an embodiment. The apparatus 700 may be provisioned on a cloud computing platform to perform the above-mentioned methods.

In FIG. 7, the apparatus includes a processing unit 702, a communication unit 704, a database 706, and a memory 710. The apparatus 700 is communicatively coupled to technical source 720 and a user device 780 via a network interface 750.

The technical source 720 is a collective term used to refer to different sources 722-728 that may generate/store the technical data. The technical sources 722-728 may be stored in across multiple systems and devices based on an origin. For example, the technical data may be sourced from print or digital versions of technical literature in books, manuals, software logs, etc. This is referred to as traditional source 722. Other sources include sensor or field data and is referred as field source 724. In addition, technical sources include expert source 726 provided in event logs via chat-box. Also, online media source 728 may be used as source of technical data. The technical data from the technical source 720 may be stored in the database 706 of the apparatus at regular/predetermined intervals.

The user device 780 serves as an access point for a user to interact with the apparatus 700. In certain embodiments, the user device 780 and the apparatus 700 are the same device, where the apparatus is provided with a user interface. In FIG. 7, the user device 780 includes a processor 782, a memory 784, and a display 786. The display 786 further includes a Graphical User Interface (GUI) 788. The GUI 788 enables the user to input a user query. Further, the GUI 788 displays response to the user query. Example user devices include a mobile computing device such as a laptop or a mobile phone. The user device may also include wearable devices provided with a display unit that is configured to receive the user query and output the response.

The response to the user query is generated by the apparatus 700 by executing instructions stored as modules in the memory 710. In the present embodiment, the memory includes a knowledge management module 715 that is configured to generate the response to the user query. The knowledge management module 715 includes a Knowledge Extraction Engine (KEE) 712, a Knowledge Base Module (KBM) 714, and an Inference Engine (IE) 716.

The KEE 712 is configured to generate a knowledge base for the technical data in the technical source 720. The KBM is configured to store the knowledge base in an effective manner to enable easy retrieval of the response. The IE 716 is configured to analyze the user query to enable effective querying of the knowledge base and thereby resulting in generating the response accurately and in a timely manner.

In an embodiment, the KEE 712 generates the knowledge base prior to receipt of the user query. The knowledge base may be generated dynamically when the technical data in the technical source 720 is updated with new technical literature any of the sources 722-728. In certain embodiments, the traditional source 722 is used as the main source of technical literature to generate the knowledge base. Further, the knowledge base may be regularly updated based on change in field source 724, expert source 726, and online media source 728. Upon execution of the KEE 712, the KEE 712 is configured to format the technical data from the technical source 720. This is in view of the varied sources and formats in which the technical data may be received from the technical sources 722-728. Formatting of the technical data provides that the knowledge base generated independent of the file type, version, etc., in which the technical data is made available. For example, the technical data in sensor logs and expert comments are converted to Portable Document Format (PDF).

Further, the KEE 712 is configured to extract textual sections in the technical data based on semantic parsing of the technical data. In an embodiment, the semantic parsing of the technical data may be unsupervised and may be performed using Markov Logic Network (MLN). The technical data is formed into logic clusters.

To enable extraction of relevant textual sections in the technical data, the KEE 712 is configured to identify ambiguous terms in the textual sections and co-reference the ambiguous terms with respect to non-ambiguous terms in the technical data. Further, the KEE 712 is configured to extract triples for the technical data with the non-ambiguous terms. The triples reflects the technical data as subject-verb-object.

Since the technical data also includes images, the KEE 712 is configured to extract relevant information from the images. The KEE 712 is configured to enhance contours of the images while reducing the dimensions of the images using a Laplacian filter. Further, the KEE 712 is configured to classify the images into different types of images as one of charts, graphs, 3-dimensional images, or 2-dimensional images using a convolutional neural network (CNN). Further, image-text in each of the images is identified. Also, determination of co-ordinates of the image-text in each of the image is performed. By determining the co-ordinates of the image-text, relevancy of the image-text is generated by the KEE 712. The knowledge base is stored as a knowledge graph by the KBM 714. The knowledge graph is a graphical representation of the knowledge base represented as logic clusters of the textual sections and the indexed images having association with each other. In other words, the knowledge graph acts as a logic relation structure for the textual sections and the indexed images in the knowledge base. For example, the KBM 714 is configured to represent triples associated with a fleet of devices that are graphically in the logic relation structure. The KBM 714 is configured to build the association between the logic clusters using a combination of Natural Language Processing techniques, Unsupervised learning techniques, and Deep learning techniques.

The IE 716 is typically executed upon receipt of the user query. When the user query is received on the user device 780, the user query is transmitted via the network interface 750 to the communication unit 704. The IE 716 is configured to determine noun-phrases in the user query based on Parts of Speech (POS) tagging and noun chunking.

The determination of the noun-phrases is used to determine the context relevancy between the user query and the knowledge base. Accordingly, the IE 716 is configured to compare the triples in the knowledge base to determine the context relevancy. Further, the IE 716 is configured to generate the relevancy score by comparing the triples in the knowledge base with the noun-phrases. In an embodiment, IE 716 is configured to determine a semantic similarity between the noun-phrases in the question with noun-phrases in the triples to generate the relevancy score. The relevancy score may be generated with respect to a semantic threshold that is predetermined for the user query. The IE 716 may also be configured to determine query-term frequency and query-inverse document frequency for the user query. The query-term frequency and query-inverse document frequency may be compared with the term frequency and the inverse document frequency of the triples to generate the relevancy score.

Further, the IE 716 is configured to determine the associated indexed image for the user query. The indexed image may be determined using a n-gram model for the matching between the user query and the caption.

In some embodiments, the user query may be long or complicated. In such embodiments, the IE 716 is configured to divide the user query into one or more sub-queries for the user query. A sub-response is generated based on the relevancy score for each of the sub-queries. Accordingly, the IE 716 is configured to generate the response to the user query based on the sub-responses.

When the response is generated, the communication unit 704 transmits the response to the user device 780. The response 780 is rendered on the GUI 788 as a panel with the relevant indexed image 788A and the relevant textual sections 788B. The apparatus 700 is an example where the Knowledge Management Module 715 is executed in a centralized manner. A person skilled in the art can appreciate that the modules KEE 712, KBM 714, and the IE 716 may be stored and executed in a distributed manner.

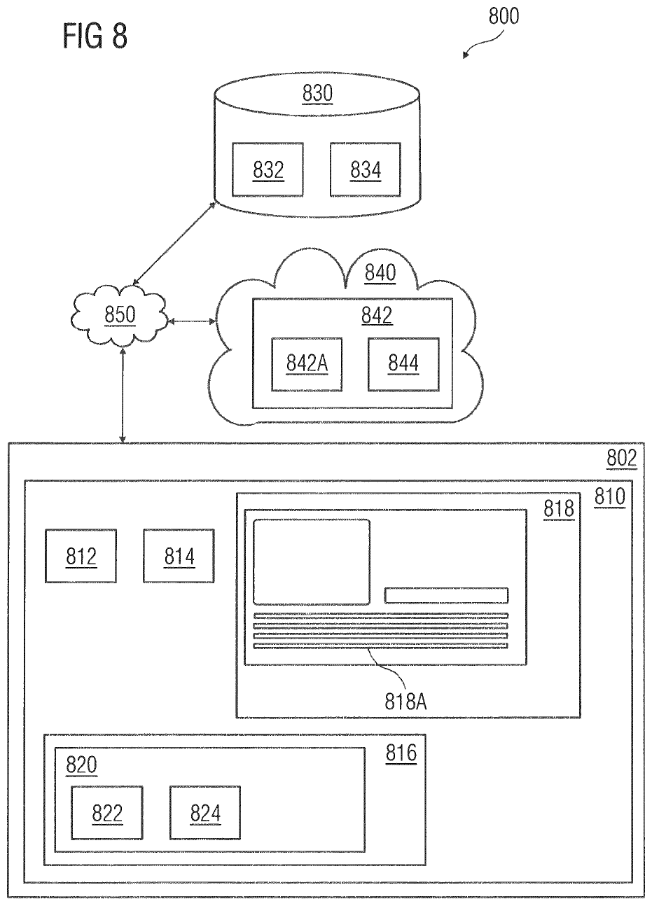

FIG. 8 illustrates a block diagram of a system 800 for managing knowledge generated from technical data, according to an embodiment. The system 800 includes an edge computing device 810 provided at a technical facility 802. For example, the technical facility 802 may be a power plant including one or more gas turbines.

The edge device 810 includes an operating system 812, a memory 814, and application runtime 816. The edge device 810 also includes a graphical user interface 818. In certain embodiments, the memory 814 may be configured to store the knowledge base 842A.

The application runtime 816 is a layer on which the one or more software applications 820 are installed and executed in real-time. The edge operating system 812 also allows running one or more software applications such as the knowledge management module 820 including an inference module 822 deployed in the edge device 810. The operation of the inference module 822 is comparable to the ID 716 in FIG. 7.

The system 800 includes a knowledge extraction system 830 configured to generate a knowledge base for the technical data. The knowledge extraction system 830 may be communicatively coupled to one or more technical sources of the technical data. For example, the technical sources may include traditional sources such as manuals and journals. The operation of the knowledge extraction system 830 is similar to the knowledge extraction engine 712 in FIG. 7.

The system 800 also includes a knowledge-based system 842 provided on a cloud computing platform 840. The knowledge-based system 842 is configured to store and manage the knowledge base 842A generated by the knowledge extraction system 830. The operation of the knowledge-based system 842 is similar to the knowledge base module 714 (when executed) in FIG. 7.

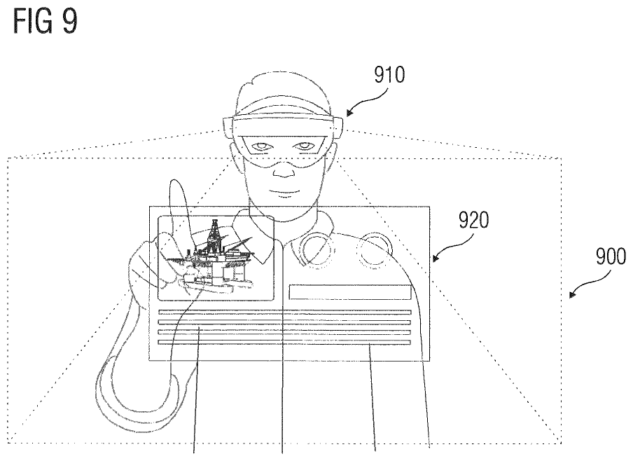

The edge device 810, the knowledge extraction system 830, and the knowledge-based system 842 are communicatively coupled via a network interface 850. In an embodiment, a user query may be initiated via the GUI 818 on the edge device 810. The user query is received on the knowledge-based system 842. The knowledge base 842A is queried based on the user query. A response 818A is generated by the inference module 822. An example response is illustrated in FIG. 9. Further, the device 810 and the systems 830, 842 include a consensus module 824, 834 and 844, respectively. The consensus module 844 generates a unique key. Further, the consensus modules 824, 834 and 844 are configured to arrive in agreement based on the unique key. The agreement is arrived amongst the edge device 810, the knowledge extraction system 830, and the knowledge-based system 842 to verify the update of the knowledge base 842A. The consensus modules enable multi-user, collaborative management of the knowledge base 842A stored in the knowledge-based system 842. The significance of the consensus module is explained in relation to different use cases.

In an example, the technical facility 802 is a power plant with gas turbines. The proprietor of the power plant maintains a knowledge base of the power plant on a third party computing plat form. The knowledge base is generated based on proprietary technical data generated from manuals associated with the power plant.

When a maintenance event occurs in the power plant, a maintenance engineer accesses the knowledge base to identify steps to perform maintenance activity. The maintenance engineer may rely on implicit domain knowledge in addition to the knowledge base. The knowledge base is updated with the maintenance logs that capture the implicit domain knowledge of the maintenance engineer. In another scenario, the maintenance engineer may be able to identify discrepancies in the knowledge base and initiate a change. Updates and changes to the knowledge base may act as reference to maintenance events in other power plants. Accordingly, change in the knowledge base may result in an impact beyond a single power plant. Therefore, it is important that stake-holders agree to the change in the knowledge base.

FIG. 9 illustrates an embodiment of a graphical user interface 900 providing a pictorial representation of a knowledge panel 920 generated on a display unit of a wearable device 910. The wearable device 910 may be used to receive a user query. The user query may be a gesture/visual-based query or an audio/voice-based query. The knowledge panel 920 is output as response to the user query. The knowledge panel 920 may include a digital representation 922 of a technical system associated with the technical data.

The foregoing examples have been provided merely for the purpose of explanation and are in no way to be construed as limiting of the present invention disclosed herein. While the invention has been described with reference to various embodiments, it is understood that the words, which have been used herein, are words of description and illustration, rather than words of limitation. Further, although the invention has been described herein with reference to particular means, materials, and embodiments, the invention is not intended to be limited to the particulars disclosed herein; rather, the invention extends to all functionally equivalent structures, methods, and uses, such as are within the scope of the appended claims.

The present invention may take a form of a computer program product including program modules accessible from computer-usable or computer-readable medium storing program code for use by or in connection with one or more computers, processors, or instruction execution system. For the purpose of this description, a computer-usable or computer-readable medium may be any apparatus that may contain, store, communicate, propagate, or transport the program for use by or in connection with the instruction execution system, apparatus, or device. The medium may be electronic, magnetic, optical, electromagnetic, infrared, or a semiconductor system (or apparatus or device). Propagation mediums in and of themselves as signal carriers are not included in the definition of physical computer-readable medium. Physical computer-readable medium may include a semiconductor or solid state memory, magnetic tape, a removable computer diskette, random access memory (RAM), a read only memory (ROM), a rigid magnetic disk and optical disk such as compact disk read-only memory (CD-ROM), compact disk read/write, and DVD. Both processors and program code for implementing each aspect of the technology may be centralized or distributed (or a combination thereof) as known to those skilled in the art.

The elements and features recited in the appended claims may be combined in different ways to produce new claims that likewise fall within the scope of the present invention. Thus, whereas the dependent claims appended below depend from only a single independent or dependent claim, it is to be understood that these dependent claims may, alternatively, be made to depend in the alternative from any preceding or following claim, whether independent or dependent. Such new combinations are to be understood as forming a part of the present specification.

While the present invention has been described above by reference to various embodiments, it should be understood that many changes and modifications can be made to the described embodiments. It is therefore intended that the foregoing description be regarded as illustrative rather than limiting, and that it be understood that all equivalents and/or combinations of embodiments are intended to be included in this description.

1. A computer-based method for managing knowledge generated from technical data, the computer-based method comprising:
receiving a user query for technical data stored as a knowledge base on a knowledge-based system;
determining, by an inference engine, a contextual relevance between the user query and the knowledge base, wherein the knowledge base comprises a queryable framework of the technical data including processed textual sections and indexed images;
identifying textual sections and images of the knowledge base associated with the user query based on the contextual relevance;
determining, by the inference engine, a relevancy score for each of the identified textual sections and indexed images based on frequency of terms in the query with respect to the identified textual sections and the indexed images; and
generating, by the inference engine, a response to the user query including extracted textual sections and indexed images having a relevancy score that exceeds a threshold.

2. The computer-based method of claim 1, further comprising:
generating, by a knowledge extraction engine, the knowledge base associated with the technical data,
wherein generating the knowledge base comprises:
formatting the technical data suitable for the query-able framework of the technical data;
extracting the textual sections in the technical data based on semantic parsing of the technical data; and
extracting the indexed images in the technical data, the extracting of the indexed images in the technical data comprising modifying the images in the technical data, such that regions of interest are identified in the images.

3. The computer-based method of claim 2, wherein extracting the textual sections in the technical data based on semantic parsing of the technical data comprises:
identifying ambiguous terms in the textual sections and the indexed images; and
co-referencing, by the inference engine, the ambiguous terms, the co-referencing of the ambiguous terms comprising mapping the ambiguous terms to non-ambiguous terms in the technical data.

4. The computer-based method of claim 3, further comprising:
extracting triples for the technical data with the non-ambiguous terms, wherein the triples reflect the technical data as subject-verb-object; and
determining term frequency and inverse document frequency for the triples.

5. The computer-based method of claim 2, wherein extracting the indexed images by modifying the images in the technical data to identify regions of interest in the images comprises:
modifying the images in the technical data to enhance contours of the images while reducing dimensions of the images; and
classifying the images into types of images using a convolutional neural network, the types of images being charts, graphs, 3-dimensional images, or 2-dimensional images.

6. The computer-based method of claim 5, further comprising:
identifying the image-text in each of the images in the technical data, wherein the image-text includes text associated with the images in the technical data;
determining the coordinates of the image-text in the image;
determining relevancy of the image-text to the textual section based on the coordinates of the image-text; and
predicting the regions of interest in the images based on image-text identified on each of the images.

7. The computer-based method of claim 6, wherein modifying the images in the technical data to enhance contours of the images while reducing the dimensions of the images comprises:
normalizing the images to a standard size while preserving aspect ratio of the images.

8. The computer-based method of claim 4, further comprising:
determining noun-phrases in the user query based on Parts of Speech (POS) tagging and noun chunking, such that the context relevancy is determined; and
generating the relevancy score, the generating of the relevancy score comprising comparing the triples in the knowledge base with the noun-phrases.

9. The computer-based method according to claim 8, wherein generating the relevancy score by comparing the triples in the knowledge base with the noun-phrases comprises:
determining a semantic similarity between the noun-phrases in the question with noun-phrases in the triples; and
identifying the matching triples having noun-phrases that have similarity above the threshold.

10. The computer-based method of claim 9, further comprising:
determining query-term frequency and query-inverse document frequency for the user query; and
comparing the query-term frequency and query-inverse document frequency with the term frequency and the inverse document frequency of the triples.

11. The computer-based method of claim 1, wherein generating the response to the user query comprises:
generating one or more sub-queries for the user query;
generating a sub-response for each of the one or more sub-queries; and
generating the response to the user query based on the sub-response.

12. The computer-based method of claim 1, wherein generating the response to the user query comprises:
visualizing the matching triples as a knowledge graph and a knowledge panel; and
rendering the knowledge graph and the knowledge panel as the response to the user query.

13. The computer-based method of claim 1, further comprising:
managing the knowledge base on a distributed consensus-based ledger.

14. An apparatus for managing knowledge generated from technical data, the apparatus comprising:
one or more processing units; and
a memory unit communicatively coupled to the one or more processing units, wherein the memory unit comprises a knowledge management module stored in the form of machine-readable instructions executable by the one or more processing units, wherein the knowledge management module is configured to manage knowledge generated from technical data, the management of the knowledge generated from the technical data comprising:
receipt of a user query for technical data stored as a knowledge base on a knowledge-based system;
determination, by an inference engine, of a contextual relevance between the user query and the knowledge base, wherein the knowledge base comprises a queryable framework of the technical data including processed textual sections and indexed images;
identification of textual sections and images of the knowledge base associated with the user query based on the contextual relevance;
determination, by the inference engine, of a relevancy score for each of the identified textual sections and indexed images based on frequency of terms in the query with respect to the identified textual sections and the indexed images; and
generation, by the inference engine, of a response to the user query including extracted textual sections and indexed images having a relevancy score that exceeds a threshold.

15. A system for managing knowledge generated from technical data, the system comprising:
a cloud computing platform comprising:
a knowledge management module configured to manage knowledge generated from technical data, the management of the knowledge generated from the technical data comprising:
receipt of a user query for technical data stored as a knowledge base on a knowledge-based system;
determination, by an inference engine, of a contextual relevance between the user query and the knowledge base, wherein the knowledge base comprises a queryable framework of the technical data including processed textual sections and indexed images;
identification of textual sections and images of the knowledge base associated with the user query based on the contextual relevance;
determination, by the inference engine, of a relevancy score for each of the identified textual sections and indexed images based on frequency of terms in the query with respect to the identified textual sections and the indexed images; and
generation, by the inference engine, of a response to the user query including extracted textual sections and indexed images having a relevancy score that exceeds a threshold.

16. (canceled)
